(19) United States
(12) Patent Application Publication
(10) Pub. No.: US 2013/0183923 A1
(43) Pub. Date: Jul. 18, 2013

(54) FIELD NURSE NOTIFICATION

(71) Applicants: Charles Cameron Brackett, Pewaukee, WI (US); Bruce Schellinger, West Bend, WI (US); Michael Harkavy, Hartland, WI (US)

(72) Inventors: Charles Cameron Brackett, Pewaukee, WI (US); Bruce Schellinger, West Bend, WI (US); Michael Harkavy, Hartland, WI (US)

(21) Appl. No.: 13/351,009

(22) Filed: Jan. 16, 2012

(51) Int. Cl. H04W 4/22; H04W 4/02

(52) U.S. Cl. 455/404.2; 455/404.1

(57) ABSTRACT

A system and method (10) are disclosed for providing home health care to a plurality of home health care patients (12) by utilizing the services of field nurses (14). The system (10) includes at least one centralized programmable processor (16) configured to respond to a field alert request (18) associated with one of the patients (12) by accessing an electronic database (20) for a patient dataset (22) specific to the patient (12) and automatically initiating a field alert in the form of a wireless communications signal (24) transmitting a portion or all of the patient dataset (22) to a wireless communications device 26 assigned to a field nurse (14).

### CROSS-REFERENCE TO RELATED APPLICATIONS

Not Applicable.

### FEDERALLY SPONSORED RESEARCH OR DEVELOPMENT

Not Applicable.

### MICROFICHE/COPYRIGHT REFERENCE

Not Applicable.

### FIELD

The application relates to systems and methods for providing health care to patients utilizing the services of a nurse, and in more particular applications to systems and methods for providing home health care to patients utilizing the services of field nurses.

### BACKGROUND

In the home health care industry, it is known to provide a monitoring nurse that remotely monitors a plurality of home health care patients. One current problem is that monitoring nurses have limited access to the patients. For example, currently when a monitoring nurse sees an issue with a patient that has sent in vitals, the monitoring nurse can only try and call the patient. Often, with the demographics home health care patients, the monitoring nurse has trouble getting through for some time, which can present a serious problem if the patient is in need of immediate medical attention.

### SUMMARY

In accordance with one feature of the application, a system is disclosed for providing home health care utilizing field nurses. The system includes at least one centralized programmable processor configured to respond to a field alert request associated with one of a plurality of home health care patients by accessing an electronic database for a patient dataset specific to the one of the home health care patients, the electronic database containing patient information for each of the plurality of home health care patients, and automatically initiating a field alert in the form of a wireless communications signal transmitting at least a portion of the patient dataset to a wireless communications device assigned to a field nurse.

In one feature, the system further includes a plurality of hand held, wireless communications devices, each wireless communications device configured to automatically display a patient alert in response to receipt of a field alert initiated by the at least one centralized programmable processor.

According to one feature, the at least one centralized programmable processor is configured to automatically select a limited number of the plurality of wireless communications devices based on criteria associated with the patient dataset and to direct the field alert specifically to the automatically selected wireless communications devices.

As one feature, the criteria includes a home health care agency that serves the one of the plurality of home health care patients, certain ones of the wireless communications devices are assigned to the home health care agency, and the at least one centralized programmable processor is configured to direct the wireless communications signal to one or more of the wireless communications devices assigned to the home healthcare nursing agency.

According to one feature, the criteria includes a home address of the one of the plurality of home health care patients, each of the wireless communications devices is configured to provide a current geographic location, and the at least one centralized programmable processor is configured to automatically direct the wireless communications signal to one or more of the wireless communications devices based on geographic proximities of the current geographic locations to the home address.

In one feature, the wireless communications device is configured to transmit a wireless communications signal indicating that the field alert has been accepted by the field nurse assigned to the wireless communications device.

As one feature, the portion of the patient dataset includes at least one of a phone number for the patient and a home address for the patient, and wherein the wireless communications device is configured to display at least one of a user selectable icon for initiating a phone call to the phone number from the wireless communications device and a user selectable icon for displaying directions to the home address from a current location of the wireless communications device.

According to one feature, the wireless communications devices is configured to accept an input of additional patient information obtained during a patient visit by the field nurse assigned to the wireless communications device and to automatically transmit the additional patient information for storage in an electronic database. As a further feature, the additional information includes one or more vital signs of the patient, or verbal or textual notes regarding the patient visit.

In one feature, the wireless communication devices is configured to display a user selectable icon allowing the field nurse to initiate a wireless communications signal transmitting a notification regarding the patient to a physician assigned to the patient.

As one feature, the wireless communications device comprises a smartphone configured to operate in a cellular telephone network.

According to one feature, the at least one centralized programmable processor is configured to transmit one or more vital signs of the patient together with the at least a portion of the patient dataset.

As one feature, the at least one centralized programmable processor is configured to access additional electronic databases to obtain additional information specific to the patient and to initiate a wireless communications signal transmitting the additional information to the wireless communications device.

In one feature, the system further includes a centralized user interface configured to display home health monitoring information for the plurality of home health care patients to a monitoring nurse and to allow the monitoring nurse to initiate the field alert request in response to the home health monitoring information for the one of the plurality of home health care patients.

As one feature, the system further includes the electronic database containing patient information for each of the plurality of home health care patients.

In accordance with one feature of the application, a method is disclosed for providing home health care utilizing field nurses. The method includes the steps of: in response to a field alert request associated with one of a plurality of home health care patients, automatically accessing an electronic database for a patient dataset of patient information specific to the one of the plurality of home health care patients, the electronic database containing patient information for each of the plurality of home health care patients; and automatically initiating a field alert in the form of a wireless communications signal transmitting at least a portion of the patient dataset to a wireless communications device assigned to a field nurse.

According to one feature, the method further includes the step of automatically selecting a wireless communications device from a plurality of wireless communications devices based on geographic proximities between a home address of the patient and the current geographic location of each of the plurality of wireless communications devices.

In one feature, the portion of the patient dataset includes at least one of a phone number and a home address of the patient and the method further includes the step of providing at least one user selectable icon on a display of the wireless communications device to allow the field nurse to initiate at least one of a phone call to the phone number and a the display of directions to the home address from the current location of the wireless communications device.

As one feature, the method further includes the step of displaying one or more user selectable icons on the wireless communications device to enable the entry of patient information into a database via the wireless communications device based on an examination by the field nurse.

According to one feature, the method further includes the step of displaying a user selectable icon on the wireless communications device allowing a field nurse to initiate a wireless communications signal transmitting a notification regarding the patient to a physician assigned to the patient.

In one feature, the method further includes the steps of monitoring the plurality of home health care patients and initiating the electronic field alert request in response to a determination made during the monitoring step.

Other features and advantages will become apparent from a review of the entire specification, including the appended claims and drawings.

### BRIEF DESCRIPTION OF THE DRAWINGS

FIG. 1 is a diagrammatic representation of a system and method for providing home health care to a plurality of home health care patients by utilizing the services of field nurses according to this disclosure;

FIGS. 2 and 3 is a representation of a user interface in the form of a computer display configured for use in the system and method of this disclosure; and

FIGS. 4 through 13 are representations of a wireless communications device in the form of a smartphone configured for use in the system and method of this disclosure.

### DETAILED DESCRIPTION

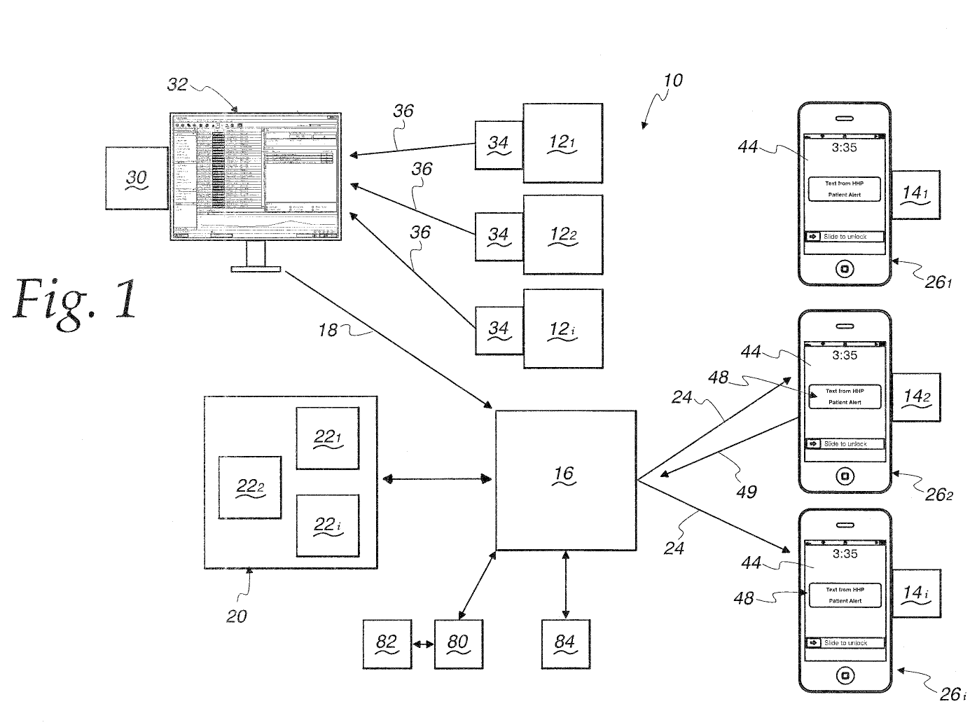

As shown diagrammatically in FIG. 1, a system and method 10 are disclosed for providing home health care to a plurality of home health care patients 12 by utilizing the services of field nurses 14. As used herein, the term “field nurse” is intended to indicate a nurse who travel to locations remote from a clinic or hospital to visit patients at the home locations of the patients to perform various services, including, for example, observing the patients, taking the vital signs of the patients, recording symptoms, reactions, and the progress the patients, giving medicine and drugs to patients according to a doctor's orders, helping patients during convalescence and rehabilitation, and instructing patients and their families in proper health care.

The system 10 includes at least one centralized programmable processor 16 shown in the form of server(s) 16 configured to respond to a field alert request, shown schematically at 18, associated with one of the patients 12 by accessing an electronic database 20 for a patient dataset 22 specific to the one patient 12, the electronic database 20 containing patient information in the forms of datasets 22 specific to each of the plurality of home health care patients 12, and automatically initiating a field alert in the form of a wireless communications signal 24 transmitting a portion or all of the patient dataset 22 to a wireless communications device 26 assigned to a field nurse 14. The patient information in each patient dataset 22 can include the patient's name, a patient ID, patient's phone number(s), patient's home address, the name of the patient's home health care agency/provider and PIN, field nurse assigned to patient and the field nurse's phone number, the name of the patient's physician(s) and associated phone number(s).

It should be understood that the at least one centralized programmable processor 16 can be a single programmable processor that is configured to operate as described herein or can be multiple programmable processors 16 that are operably are configured and operably associated with each other to operate as described herein. For convenience, the phrase “centralized programmable processor 16” will be used for the remainder of the Detailed Description when referring to the at least one centralized programmable processor 16.

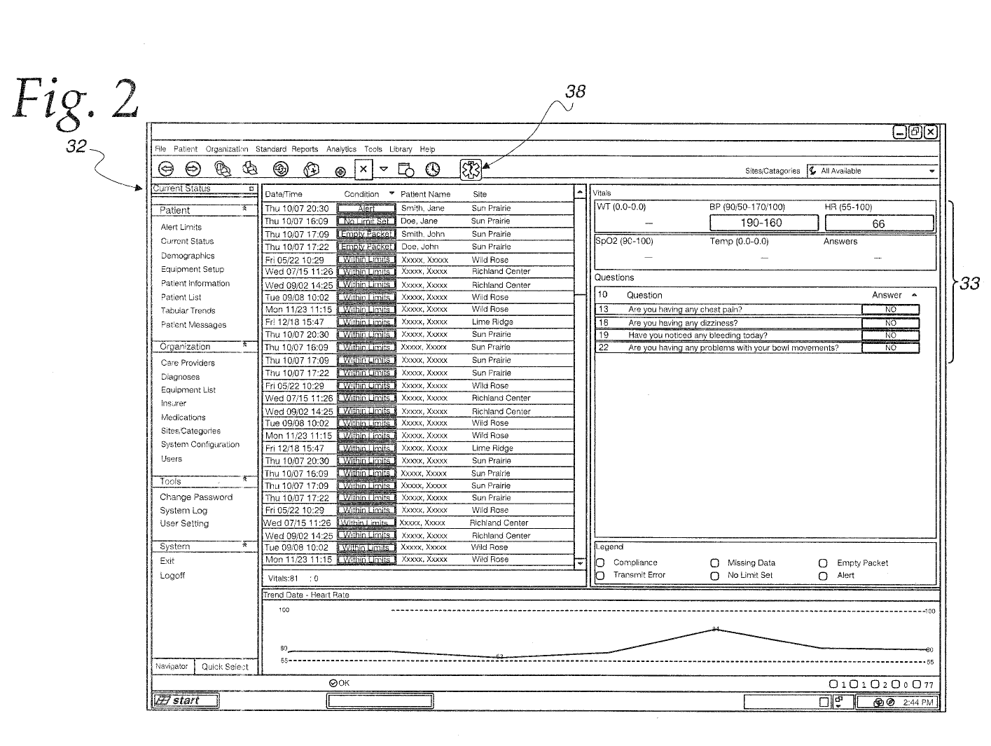

With reference to FIG. 1, the field alert request 18 is initiated by a monitoring nurse 30 for a home health care agency (HHA) who utilizes any suitable and known system to monitor a plurality of the patients 12, such as by monitoring the plurality of the patients 12 using a centralized user interface 32, such as the illustrated computer monitor 32. The user interface 32 is configured to display home health monitoring information, as shown at 33 in FIG. 2 in the form of the patient vital signs and health question responses, for the monitored patients 12, with the information typically being provided for each 12 patient electronically by a home monitor unit 34 (FIG. 1) at the patient's home that accumulates the information and transmits it to the user interface 32 via any suitable electronic communications system 36, which will typically include phone systems and/or internet connections. The user interface 32 is also configured to allow the monitoring nurse 30 to initiate the field alert request 18 in response to an anomaly in the home health monitoring information for any one of the patients 12, such as by selecting selectable icons 38 and 39, as shown in FIGS. 2 and 3. Typically, the monitoring nurse 30 will attempt to contact a patient 12 before initiating the field alert request 18. The user interface 32 is also configured to allow the monitoring nurse 30 to input comments prior to sending the field alert request 18, as shown at 40 in FIG. 3. In this regard, in addition to information from the patient dataset 22 that is forwarded in the field alert 24, the field alert 24 can include the comments 40 inputted by the monitoring nurse 30 together with the vital signs and/or questions 33. It should also be understood that the centralized processor 16 and the user interface 32 are configured and operably associated such that both devices can send and receive information to the other device, such as, for example, a information forwarded from the processor 16 to the user interface 32 regarding the status of the field alert request 18 and associated patient 12 and field nurses(s) 14 based on the information provided back to the processor 16 from the wireless communications devices 26.

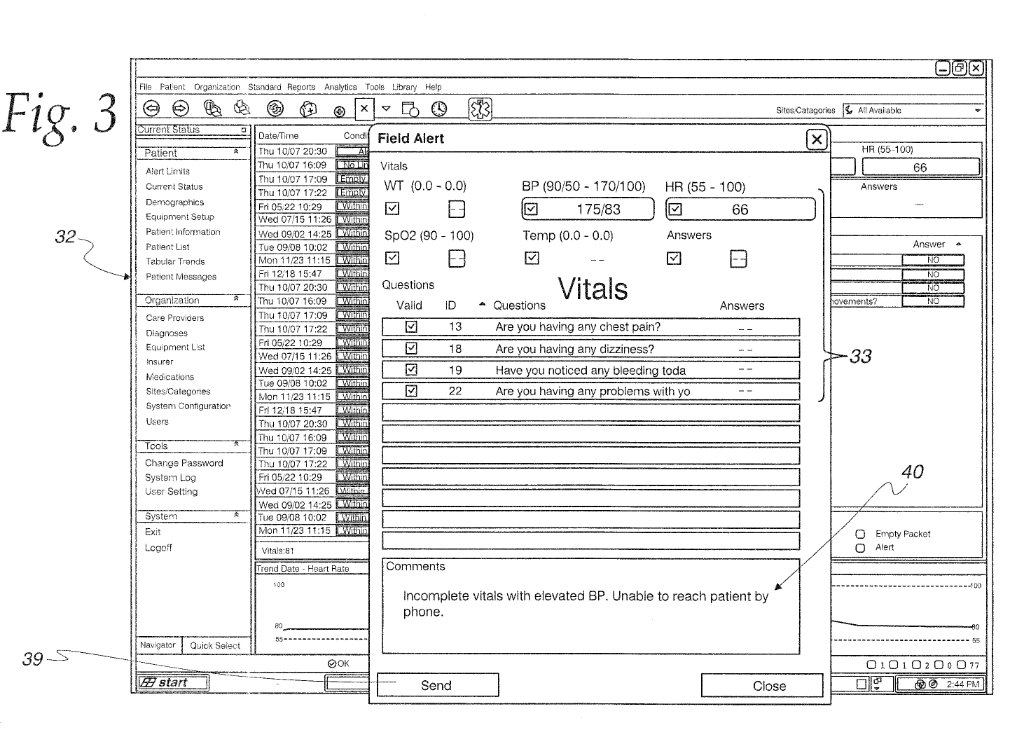

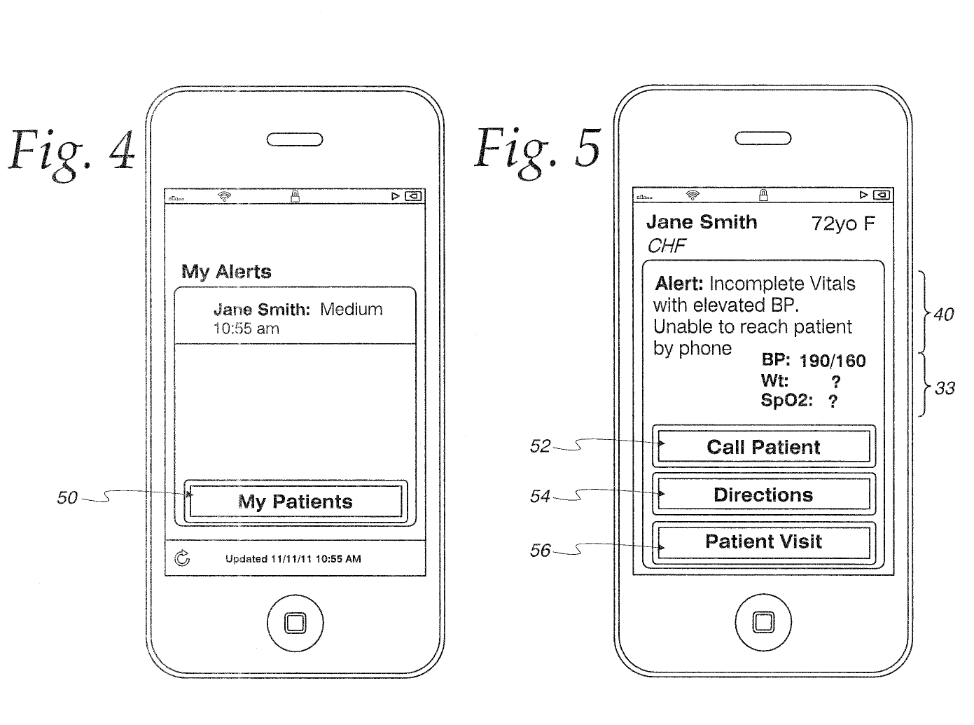

With reference to FIG. 1, the system 10 can include a plurality of the wireless communications devices 26, shown in the form of personal, hand held, wireless communications devices 26 such as a smartphone 26, one common example of which is the iPhone produced and sold by Apple Inc. Each wireless communications device 26 will typically include a radio transceiver to send and receive wireless communications signals, a user interface such a touch screen display 44, and a programmable processor in the form of a microprocessor operably connected to the transceiver, the user interface 44, and the remainder of the device 26 for operation of the device 26. Each wireless communications device 26 is configured to automatically display a patient alert, as shown at 48 in FIG. 1, in response to receipt of a field alert 24 initiated by the centralized programmable processor 16 and directed to the wireless communications device 26, usually via a cellular telephone number assigned to the device 26 or via an Internet Protocol address (IP address) assigned to the device 26. Each device 26 can also be configured to send a wireless communications signal 49 back to the centralized programmable processor 16 indicating that the field nurse 14 assigned to the device 26 has accepted the field alert 24 in response to an input from the field nurse 14, such as a selection of a selectable icon, such as the “My Patients” icon 50 shown in FIG. 4, by the field nurse 14. This can allow the centralized programmable processor 16 to send out another wireless communications signal indicating that the field alert has been accepted by the field nurse 14 to any other wireless communications devices 26 that may have received the field alert 24.

The centralized programmable processor 16 can be configured to automatically select a limited number of the plurality of wireless communications devices 26 based on criteria associated with the patient dataset 22 for any specific patient 12 and to direct the field alert 24 specifically to the automatically selected wireless communications devices 26. In this regard, the criteria can include the home health care agency that serves the patient 12 needing a field alert, with certain ones of the wireless communications devices 26 being assigned to that home health care agency, and the centralized programmable processor 16 being configured to direct the wireless communications signal for the field alert 24 to one or more of those wireless communications devices 26 so only those devices 26 that are assigned to the home healthcare nursing agency that serves the patient 12 needing the field alert 24 will receive the field alert 24. In addition to the above or as an alternative to the above, the criteria can include the home address of the patient 12 needing the field alert 24, with each of the wireless communications devices 26 being configured using any suitable and known method to provide a current geographic location of the device 26, such as via global positioning system protocols, and the centralized programmable processor 16 being configured to automatically direct the wireless communications signal for the field alert 24 to one or more of the wireless communications devices 26 based on geographic proximities of the current geographic locations to the home address. In this regard, the centralized programmable processor 16 would select the wireless communications device or devices 26 whose current geographic location(s) are nearest to the home address. As another alternative or addition, the centralized programmable processor can be configured to send the field alert 24 to the device 26 of a field nurse 14 that is assigned to the patient 12 needing the field alert 24.

Each of the devices 26 can be configured to display information about the patient 12 that was transmitted in connection with the field alert 18, such as the patient's name, age, and gender; the vital signs and/or questions 33 for the patient 12 and any notes 40 input by the monitoring nurse 30, all as shown in FIG. 5. This information assists the field nurse 14 in understanding the nature and cause of the field alert 24 prior to contact with the patient 12.

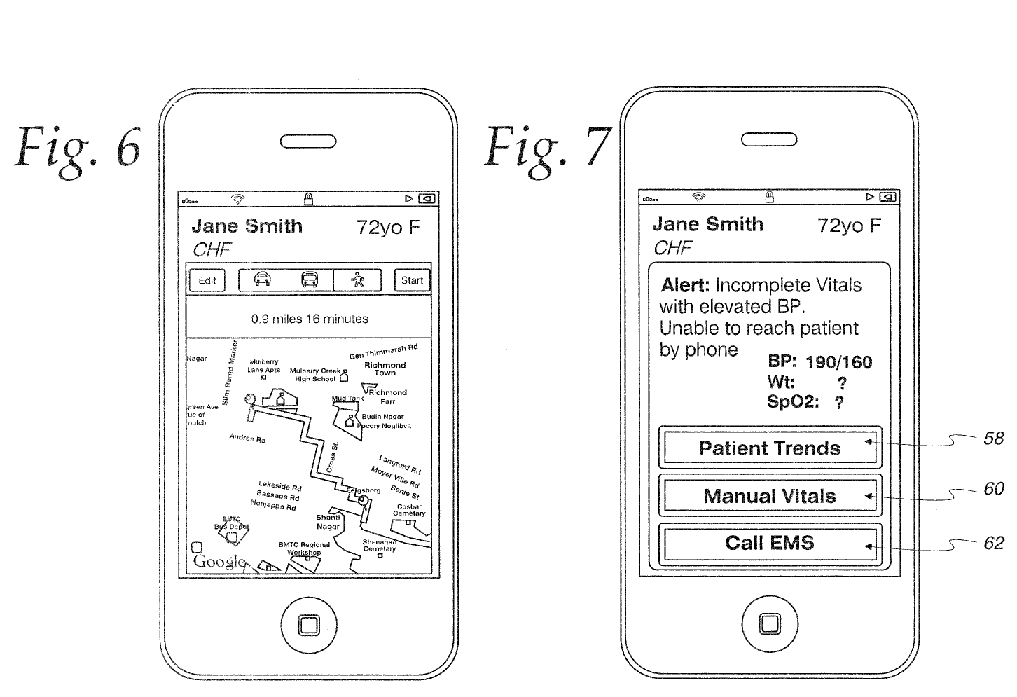

The information from the patient dataset 22 transmitted with the field alert 24 can include the phone number and the home address of the patient 12, and each of the wireless communications devices 26 can be configured to display a user selectable icon, such as the “Call Patient” icon 52 in FIG. 5, for initiating a phone call to the patient's phone number from the wireless communications device 26 and a user selectable icon, such as the “Directions” icon 54 in FIG. 5, for displaying directions, distance, and travel time to the patient's home address from a current location of the wireless communications device 26, as shown in FIG. 6.

As shown in FIG. 5, each of the wireless communications devices 26 can be configured to display a user selectable icon, such as the “Patient Visit” icon 56, that allows the field nurse 14 to initiate the display of a patient evaluation/visit screen, such as shown in FIG. 7, which includes further user selectable icons, such as the “Patient Trends” icon 58 and the “Manual Vitals” icon 60 which activate additional input screens, and the “Call EMS” icon 62 in FIG. 7 which initiates a phone call to Emergency Medical Services.

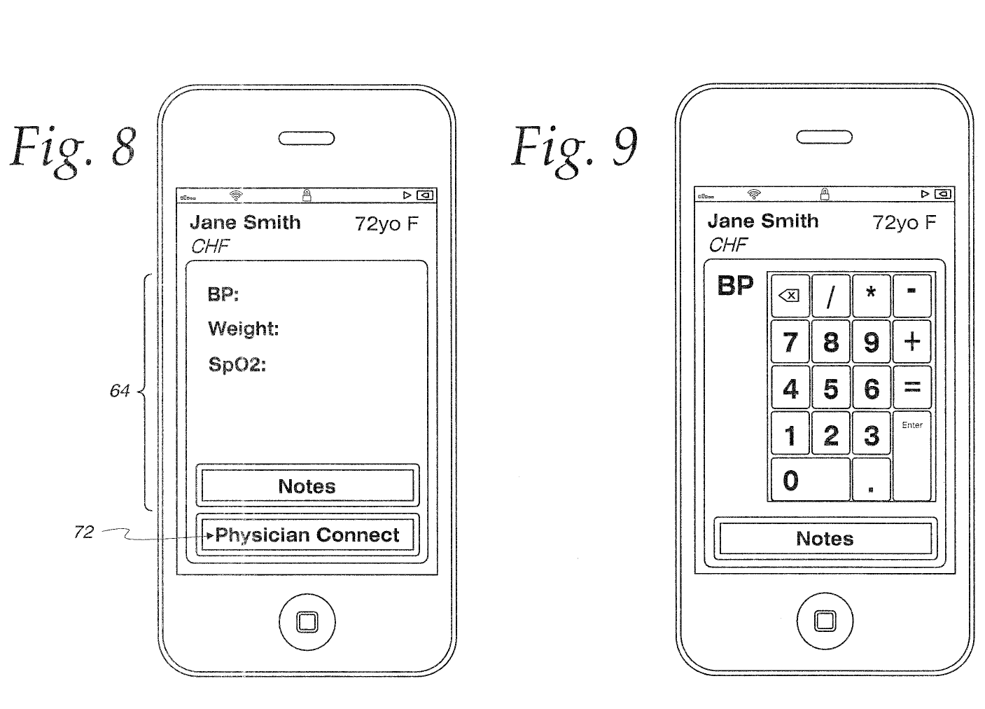

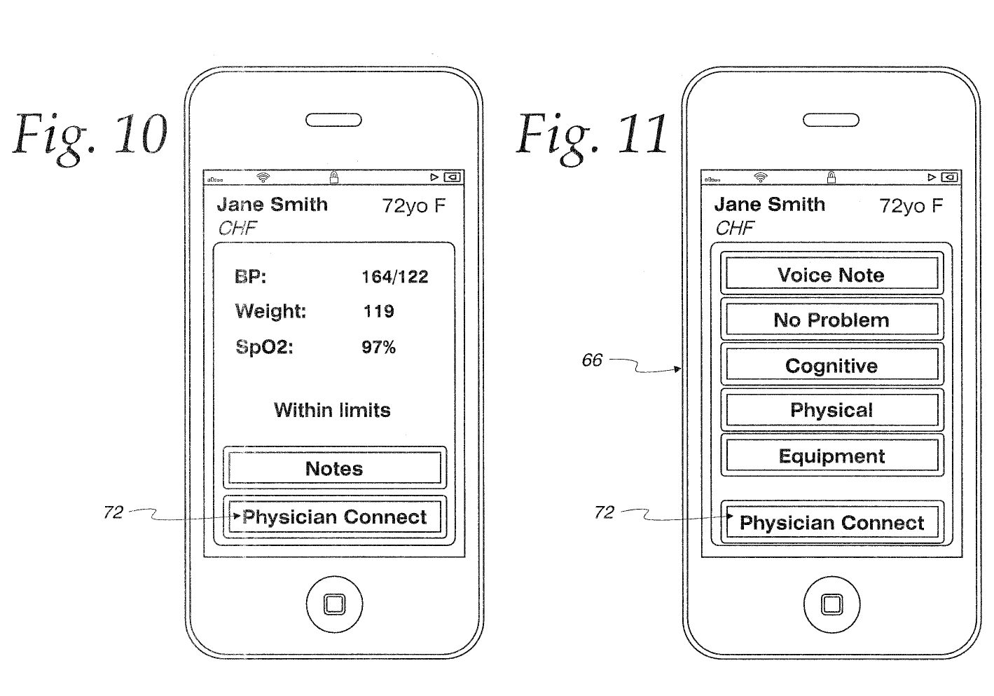

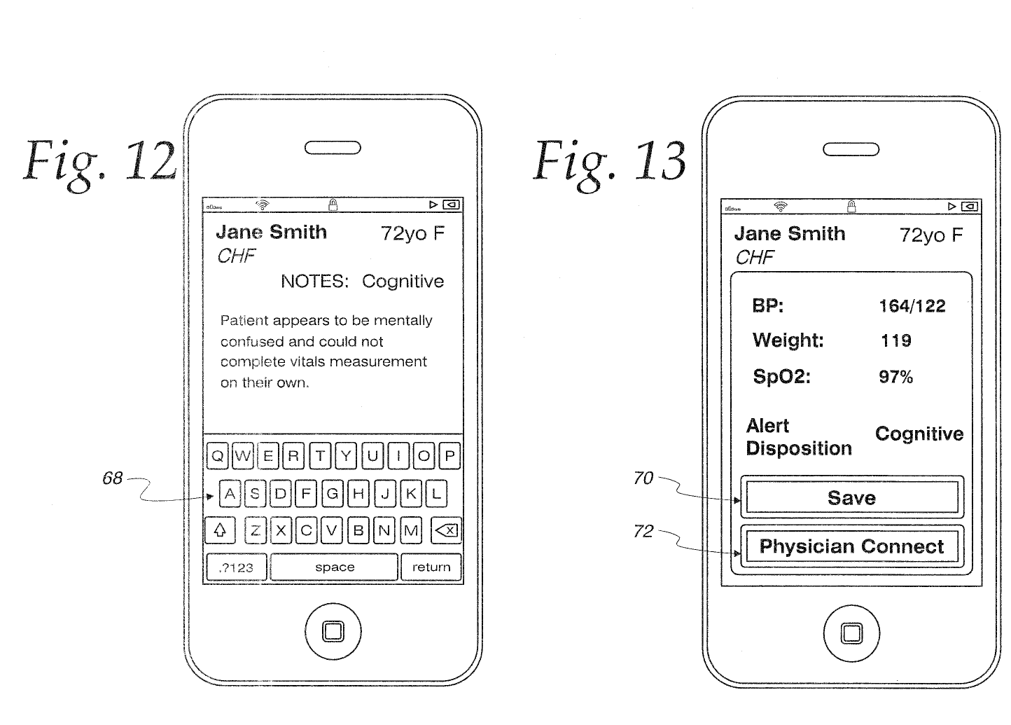

As shown at in FIGS. 8-11, each of the wireless communications devices 26 can be configured to accept an input of additional patient information obtained during a patient visit by the field nurse 14 assigned to the wireless communications device 26 and to automatically transmit the additional patient information for storage in an electronic database, including a database in the device 26 and/or the database 20. This feature can be initiated via a user selectable icon, such as the “Manual Vitals” icon 60 shown in FIG. 7. which activates an input screen such as is shown in FIG. 8 which provides the ability for further input, such as by the user selectable “BP” (blood pressure), Weight, “SpO2” (oxygen saturation), and “Notes” icons 64 shown in FIG. 8. This additional information can include one or more vital signs of the patient, and notes regarding the patient visit, with the vital sign icons activating a numeric keypad entry screen such as shown in FIG. 9 and the resultant entries being displayed such as shown in FIG. 10; and the “Notes” icon activating a notes screen such as shown in FIG. 11 with further user selectable icons 66 activating entry screens, such as shown in FIG. 12 that includes a qwerty entry keypad 68. As shown in FIG. 13, each of the devices 26 can further be configured to display a screen showing the information input by the field nurse 14 and providing a user selectable icon, such as the “Save” icon 70, that initiates a transmission of the entered information into a database, as previously discussed. It should be understood that while some specific examples of additional information have been described above, those examples are not intended to be limiting, and that any additional information that would be of assistance in helping a patient 12 is contemplated. Thus, for example, while examples are provided above of specific vital signs, any vital sign that may be of assistance is contemplated herein.

As shown in FIGS. 8, 10, 11, and 13, each of the wireless communication devices 26 can be configured to display a user selectable icon, such as the “Physician Connect” icon 72, allowing the field nurse 14 to initiate a wireless communications signal to provide a notification and/or details regarding the patient visit to a physician assigned to the patient.

As shown in FIG. 1, the centralized programmable processor 16 can be configured to access additional electronic databases and programmable processors, such as a home health care agency processor 80 and personal health record (PHR) electronic database 82 and/or an electronic health record (HER) database/programmable processor 84, to obtain or provide additional information specific to a patient 12 and to initiate a wireless communications signal transmitting the additional information to the wireless communications devices 26.

Each of the wireless communications devices 26 can be configured as described above by downloading, via any suitable and known protocol, one or more programs or “apps” written in any known and suitable programming language(s)/protocol(s) that will configure the particular programmable processor(s) in each of the devices 26. Similarly, the centralized programmable processor 16 can be configured as described above by downloading, via any suitable and known protocol, one or more programs or “apps” written in any known and suitable programming language(s)/protocol(s) that will configure the programmable processor 16.

The disclosed system and method 10 provides the monitoring nurses 30 with a new tool to reach that patient in question. All agencies have nurses 14 out in the field visiting patients and more and more of the field nurses 14 are moving to smartphones for better communications with their agency. The disclosed system and method 10 takes advantage of these trends by providing a smartphone app that will allow the monitoring nurse 30 to contact the field nurses 14 to redirect them to a patient 12 of interest.

It should be appreciated that will specific embodiments have been described herein, the system and method 10 may take many forms within the scope of the application and that specific details of the disclosure should not be read into any appended claim unless specifically recited in the claim.

1. (canceled)

2. (canceled)

3. (canceled)

4. The system of claim 5 wherein the criteria comprises a home health care agency that serves the one of the plurality of home health care patients, certain ones of the wireless communications devices are assigned to the home health care agency, and the at least one centralized programmable processor is configured to direct the wireless communications signal to one or more of the wireless communications devices assigned to the home healthcare nursing agency.

5. A system for providing home health care utilizing field nurses, the system comprising:
at least one centralized programmable processor configured to respond to a field alert request associated with one of a plurality of home health care patients by accessing an electronic database for a patient dataset specific to the one of the home health care patients, the electronic database containing patient information for each of the plurality of home health care patients, and automatically initiating a field alert in the form of a wireless communications signal transmitting at least a portion of the patient dataset to a wireless communications device assigned to a field nurse
a plurality of hand held, wireless communications devices, each wireless communications device configured to automatically display a patient alert in response to receipt of a field alert initiated by the at least one centralized programmable processor and
at least one centralized programmable processor is configured to automatically select a limited number of the plurality of wireless communications devices based on criteria associated with the patient dataset and to direct the field alert specifically to the automatically selected wireless communications devices: and
wherein the criteria comprises a home address of the one of the plurality of home health care patients, each of the wireless communications devices is configured to provide a current geographic location, and the at least one centralized programmable processor is configured to automatically direct the wireless communications signal to one or more of the wireless communications devices based on geographic proximities of the current geographic locations to the home address.

6. A system for providing home health care utilizing field nurses, the system comprising:
at least one centralized programmable processor configured to respond to a field alert request associated with one of a plurality of home health care patients by accessing an electronic database for a patient dataset specific to the one of the home health care patients, the electronic database containing patient information for each of the plurality of home health care patients, and automatically initiating a field alert in the form of a wireless communications signal transmitting at least a portion of the patient dataset to a wireless communications device assigned to a field nurse; and
the wireless communications device, and wherein the wireless communications device is configured to transmit a wireless communications signal indicating that the field alert has been accepted by the field nurse assigned to the wireless communications device in response to a manual input by the field nurse.

7. The system of claim 5 wherein the portion of the patient dataset further comprises a phone number for the patient and the wireless communications device is configured to display a user selectable icon for initiating a phone call to the phone number from the wireless communications device and a user selectable icon for displaying directions to the home address from a current location of the wireless communications device.

8. The system of claim 5 further comprising the wireless communications device, wherein the wireless communications device is configured to accept an input of additional patient information obtained during a patient visit by the field nurse assigned to the wireless communications device and to automatically transmit the additional patient information for storage in an electronic database remote from the wireless communications device.

9. The system of claim 8 wherein the additional information comprises one or more vital signs of the patient, or verbal or textual notes regarding the patient visit.

10. The system of claim 5 further comprising the wireless communications device, and wherein the wireless communications device is configured to display a user selectable icon allowing the field nurse to initiate a wireless communications signal transmitting a notification regarding the patient to a physician assigned to the patient.

11. The system of claim 5 wherein the wireless communications device comprises a smartphone configured to operate in a cellular telephone network.

12. The system of claim 5 wherein the at least one centralized programmable processor is configured to transmit one or Gore vital signs of the patient together with the at least a portion of the patient dataset.

13. The system of claim 5 wherein the at least one centralized programmable processor is configured to access additional electronic databases to obtain additional information specific the patient and to initiate a wireless communications signal transmitting the additional information to the wireless communications device.

14. The system of claim 5 further comprising a centralized user interface configured to display home health monitoring information for the plurality of home health care patients to a monitoring nurse and to allow the monitoring nurse to initiate the field alert request in response to the home health monitoring information for the one of the plurality of home health care patients.

15. The system of claim 5 further comprising the electronic database containing patient information for each of the plurality of home health care patients.

16. (canceled)

17. A method for providing home health care utilizing field nurses, the method comprising the steps of:
in response to a field alert request associated with one of a plurality of home health care patients, automatically accessing an electronic database for a patient dataset of patient information specific to the one of the plurality of home health care patients, the electronic database containing patient information for each of the plurality of home health care patients, and
automatically initiating a field alert in the form of a wireless communications signal transmitting at least a portion of the patient dataset to a wireless communications device assigned to a field nurse,
further comprising the step of automatically selecting a wireless communications device from a plurality of wireless communications devices based on geographic proximities between a home address of the patient and the current geographic location of each of the plurality of wireless communications devices.

18. The method of claim 17 wherein the portion of the patient dataset comprises at least one of a phone number and a home address of the patient and further comprising the step of providing at least one user selectable icon on a display of the wireless communications device to allow the field nurse to initiate at least one of a phone call to the phone number and a the display of directions to the home address from the current location of the wireless communications device.

19. The method of claim 17 further comprising the step of displaying one or more user selectable icons on the wireless communications device to enable the entry of patient information into a database via the wireless communications device based on an examination by the field nurse.

20. The method of claim 16 further comprising the step of displaying a user selectable icon on the wireless communications device allowing a field nurse to initiate a wireless communications signal transmitting a notification regarding the patient to a physician assigned to the patient.

21. The method of claim 16 claim 17 further comprising the steps of monitoring the plurality of home health care patients and initiating the electronic field alert request in response to a determination made during the monitoring step.
